(19) United States
(12) Patent Application Publication
(10) Pub. No.: US 2025/0179865 A1
(43) Pub. Date: Jun. 5, 2025

(54) WINDOW LITE FRAME SYSTEMS AND METHODS

(71) Applicant: OVERHEAD DOOR CORPORATION, Lewisville, TX (US)

(72) Inventor: Bradley J. Lee, Arlington, TX (US)

(21) Appl. No.: 18/525,214

(22) Filed: Nov. 30, 2023

(51) Int. Cl. E06B 3/54; E06B 3/26; E06B 3/70

(52) U.S. Cl. CPC E06B 3/549; E06B 3/26; E06B 3/70; E06B 2003/7044

(57) ABSTRACT

A frame assembly comprises a first frame member abuttable against a first side of a window. The first frame member has first integrated connectors. At least one of the first integrated connectors is a prong connector. The frame assembly further comprises a second frame member abuttable against an opposing side of the window. The second frame member has second integrated connectors. At least one of the second integrated connectors is a receptacle connector. The prong connector is configured to mate with the receptacle connector to secure the window between the first frame member and the second frame member.

### FIELD

The present disclosure relates to window frames, and more particularly to movable barrier window lite frame systems and methods.

### BACKGROUND

Window lites are separately formed windowpanes. They can be used in doors, walls, vehicles, garage doors, and other suitable structures. For example, movable barriers often incorporate window lites in garage door section panels. Each window lite is typically secured to the surrounding structure using a window lite frame. Traditional window lite frames involve complex designs and require large quantities of separable components, leading to high manufacturing costs. Furthermore, traditional window lite frames are difficult and time-consuming to install in movable barriers and other structures. Therefore, there is a need to provide simple window light frames that do not include many components.

### SUMMARY

The examples of the invention are summarized by the claims that follow the description.

In some examples, a frame assembly may comprise a first frame member abuttable against a first side of a window and having first integrated connectors, wherein at least one of the first integrated connectors is a prong connector, a second frame member abuttable against an opposing side of the window and having second integrated connectors, wherein at least one of the second integrated connectors is a receptacle connector, wherein the prong connector is configured to mate with the receptacle connector to secure the window between the first frame member and the second frame member.

In some examples, a frame member for securing a window in an opening in a movable barrier may comprise a base portion abuttable against the movable barrier, the base portion being sized larger than an opening in the movable barrier, an insert portion extending inwardly from the base portion and abuttable against the window, the insert portion being sized to fit within an opening in the movable barrier, a plurality of integrated connectors extending inwardly from the base portion; and a window opening defined by the insert portion.

In some examples, a method of securing a window in a movable barrier may comprise positioning an inner side of a first frame member having first integrated connectors against an exterior side of the movable barrier, abutting a side of a window against the inner side of the first frame member, positioning an inner side of a second frame member having second integrated connectors against an interior side of the movable barrier, abutting the inner side of the second frame member against an opposing side of the window, and mating the second integrated connectors with the first integrated connectors to secure the window in the movable barrier between the first frame member and the second frame member.

In some examples, a snap fit connector comprises a prong having a perimeter with at least one first interference feature extending about the perimeter, and a receptacle having a cavity defined by an inner wall, the inner wall having a second interference feature extending along the inner wall, the receptacle having an open end configured to receive the prong and having a side access opening sized to provide access to and aligned with the second interference feature, at least one of the prong and the receptacle being elastically deflectable in manner allowing the first interference feature to snap fit with the second interference feature to secure the post in the socket when in use.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

The accompanying drawings illustrate implementations of systems, devices, and methods disclosed herein and together with the description, serve to explain the principles of the present disclosure.

FIG. 1 is a front view of a movable barrier, according to examples of the present disclosure.

FIG. 2 is a perspective view of a window lite frame assembly in a movable barrier, according to examples of the present disclosure.

FIG. 3 is an exploded view of a window lite frame assembly and a movable barrier, according to examples of the present disclosure.

FIG. 4 is a perspective view of a frame member, according to examples of the present disclosure.

FIG. 5 is a perspective view of a portion of a frame member, according to examples of the present disclosure.

FIG. 6 is a perspective view of a portion of a frame member, according to examples of the present disclosure.

FIG. 7 is a perspective section view of a window lite frame assembly in a movable barrier, according to examples of the present disclosure.

FIG. 8 is a perspective section view of a window lite frame assembly in a movable barrier, according to examples of the present disclosure.

FIG. 9 is an illustrative method for securing a window in a movable barrier, according to aspects of the present disclosure.

These Figures may be better understood by reference to the following Detailed Description.

### DETAILED DESCRIPTION

For the purpose of promoting an understanding of the principles of the present disclosure, reference will now be made to the examples illustrated in the drawings and specific language will be used to describe them. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In addition, this disclosure describes some elements or features in detail with respect to one or more implementations or Figures, when those same elements or features appear in subsequent Figures, without such a high level of detail. It is fully contemplated that the features, components, and/or steps described with respect to one or more implementations or Figures may be combined with the features, components, and/or steps described with respect to other examples or Figures of the present disclosure. For simplicity, in some instances the same or similar reference numbers are used throughout the drawings to refer to the same or like parts.

The present disclosure relates to window frames, and more particularly, movable barrier window lite frame systems and methods. The disclosed examples may provide additional advantages including, but not limited to securing a window to a structure using minimal and integrated components, decreasing manufacturing costs of window lite frame members, decreasing the time and complexity of installing a window in a structure, and providing an ambidextrous and versatile window lite frame member for use in a window lite frame assembly.

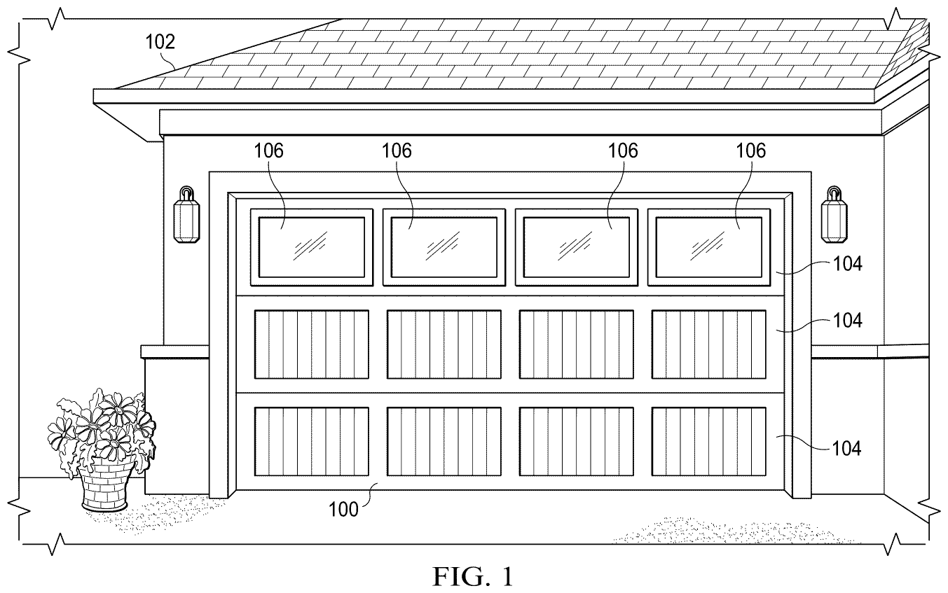

FIG. 1 shows an example movable barrier 100 acting as a barrier to entry into a garage of a building 102. In this example, the movable barrier 100 is an upward acting garage door. In some examples, the movable barrier 100 may be a sectional-type garage door. In some examples, as shown in FIG. 1, the movable barrier 100 may include three stacked sections 104. The sections 104 may include various panels formed of opaque, transparent, or semi-transparent materials. The sections 104 of the movable barrier 100 may include windows 106, allowing light to shine through the movable barrier 100. In some examples, the windows 106 may be window lites (separately framed windowpanes). The windows 106 may be panes of glass or other transparent or semi-transparent materials. The example frame members described herein are not limited to use with windows and can be used with any other material besides glass that may need to be framed in a simple manner without many components. This includes materials that are not transparent.

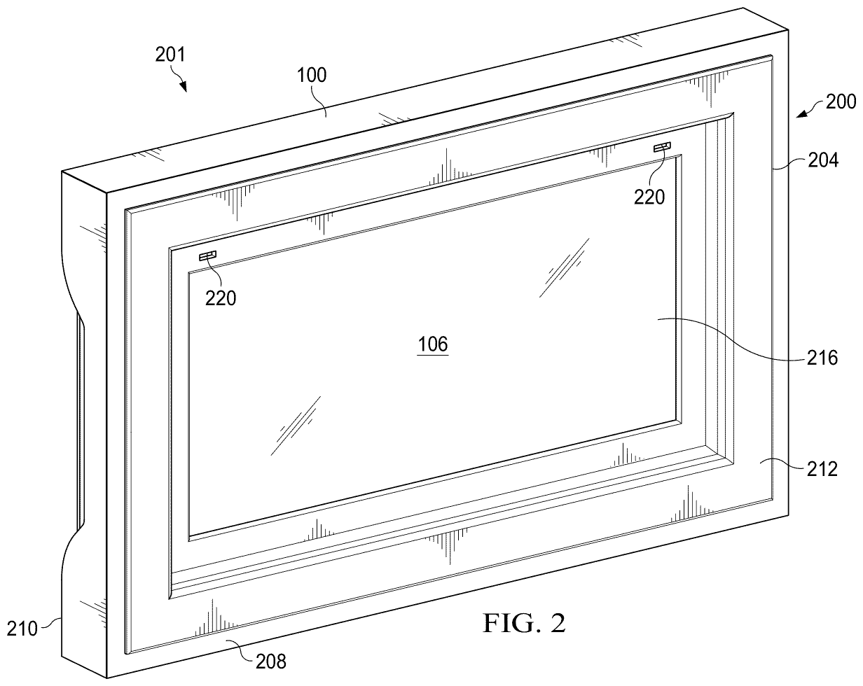

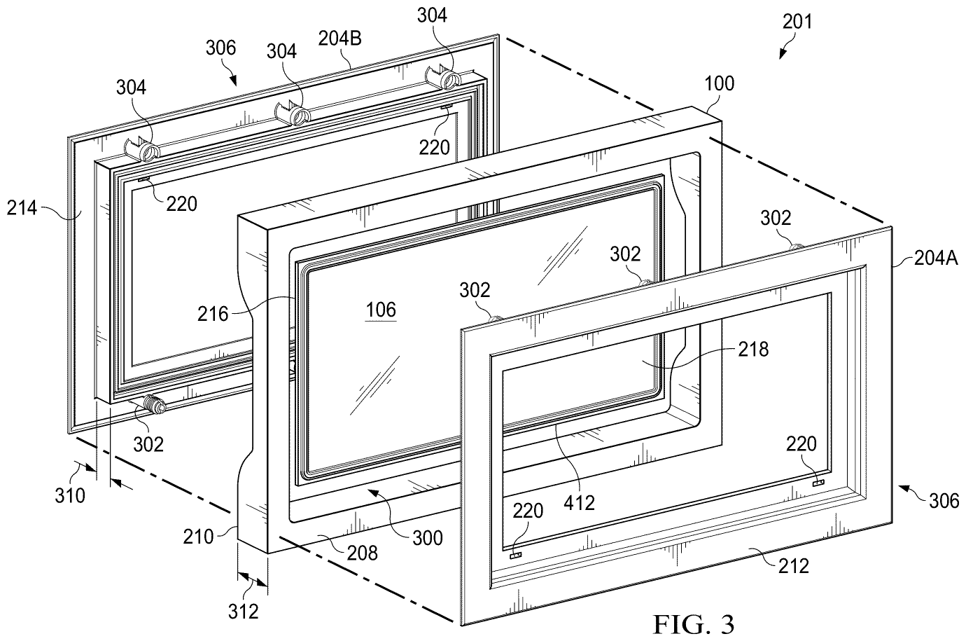

FIG. 2 shows an example window lite frame assembly 200 secured within a structure, which in this example, is the movable barrier 100. Together, the moveable barrier 100 and the window lite frame assembly 200 create a windowed structure 201. In other examples, the structure identified as the movable barrier 100 in FIG. 2 is not a movable barrier, but may be another structure with which the window lite frame assembly 200 may cooperate. For simplicity, FIG. 2 only shows a portion of the movable barrier 100, (e.g., a portion of one of the sections 104 from FIG. 1). The movable barrier 100 has an exterior side 208 and an interior side 210. For example, when the structure is the movable barrier 100, the exterior side 208 may face the outdoors and the interior side 210 may face inwardly when the movable barrier 100 is in a closed position. The window lite frame assembly 200 may include one or more frame members 204 and the window 106. Sometimes dual pane windows 106 may be included for insulative or security purposes. The frame member 204 has an outer side 212 and an inner side 214 (shown in FIG. 3). The window 106 has a side 216 and an opposing side 218. The frame member 204 is abuttable against the side 216 of the window 106. Another frame member 204 is abuttable against the opposing side 218 of the window 106.

In some examples, the frame member 204 may have one or a plurality of weep holes configured to allow water that is accumulates between the window 106 and the frame member 204 to seep out. The weep holes 220 function to prevent water buildup that can lead to mold or fogging. In some examples, portions of the frame member 204 may be angled to direct any accumulated water towards the weep holes 200. The weep holes 220 may be positioned towards the bottom of the frame member 204 because water is more likely to flow towards the bottom of the frame member 204 due to gravity. However, in some examples, the weep holes 220 may be positioned on the sides or the top of the frame member 204. When positioned on the sides, the weep holes 220 may be configured to allow water running downwards toward the bottom of the frame member 204 to seep from the frame member 204 before ever reaching the bottom. Weep holes 220 which are positioned on the top part of the frame member 204 may be configured to allow water to evaporate that has accumulated between the top portion of the window 106 and the top portion of the frame member 204.

FIG. 3 shows the window lite frame assembly 200 having two frame members 204. In this example, the frame members 204 are disassembled and separated from the window 106 and the movable barrier 100. One of the frame members 204 can be used as an exterior frame member 204A and the other frame member 204 can be used as an interior frame member 204B. The exterior frame member 204A is shown positioned on the exterior side 208 of the movable barrier 100, while the interior frame member 204B is positioned on the interior side 210. In some examples the exterior frame member 204A and the interior frame member 204B are identical or substantially the same. For visualization purposes, the window 106 is positioned suspended within a rough opening 300 in the movable barrier 100.

The frame members 204A, 204B are shown having both prong connectors 302 and receptacle connectors 304. In some examples, the prong connectors 302 and the receptacle connectors 304 on opposing frame members 204A, 204B are configured and positioned to mate with each other when the exterior frame member 204A and the interior frame member 204B are pushed together. As the frame members 204 are pushed together, the connectors 302 and 304 mate with one another, securing the window 106 between the frame members 204 and within the rough opening 300 in the movable barrier 100. In some examples, connecting the connectors 324, 304 includes snapping the frames 204 together. The assembly process may not require the use of tools or other components.

In some examples, the frame members 204 are shaped and configured to fit within the rough opening 300. In some examples, the frame members 204 are shaped and configured to couple and/or nest within the movable barrier 100. The frame members 204 may include a base portion 306 and an insert portion 308. The insert portion 308 may extend inwardly towards the window 106 from the base portion 306. In some examples, the insert portion 308 is sized to be inserted into the rough opening 300, while the base portion 306 is too big to fit within the rough opening 300. The base portion 306 may abut against the exterior side 208 of the structure or movable barrier 100.

In some examples, to accommodate a thin window, a width 310 of the insert portion 308 of the frame member 204 is roughly half a width 312 of the rough opening 300 or the movable barrier 100. When two of the insert portions 308 are inserted into the rough opening 300, their combined widths are generally comparable to the width 312 of the rough opening 300. In this way, the insert portions 308 can abut against opposing sides of the window 106 to secure the window 106 within the rough opening 300. The width 310 of the insert portion 308 can vary to accommodate windows of varying thicknesses as well as movable barriers or other structures of varying thicknesses.

It is understood that one may want to position the window 106 at different widths along the width 312 of the rough opening. For example, it may be desirable that the window 106 be flush or close to flush with the exterior side 208 of the movable barrier 100. The widths 310 of the insert portions 308 on the frame members 204 can vary independent of one another to accommodate these examples. The exterior frame member 204A may have an insertion portion with little to no width, while the interior frame member 204B may have a width that is similar to the width 312 of the rough opening 300. In some examples, one of the frame members 204 may not have the insert portion 308 at all and may just include the base portion 306.

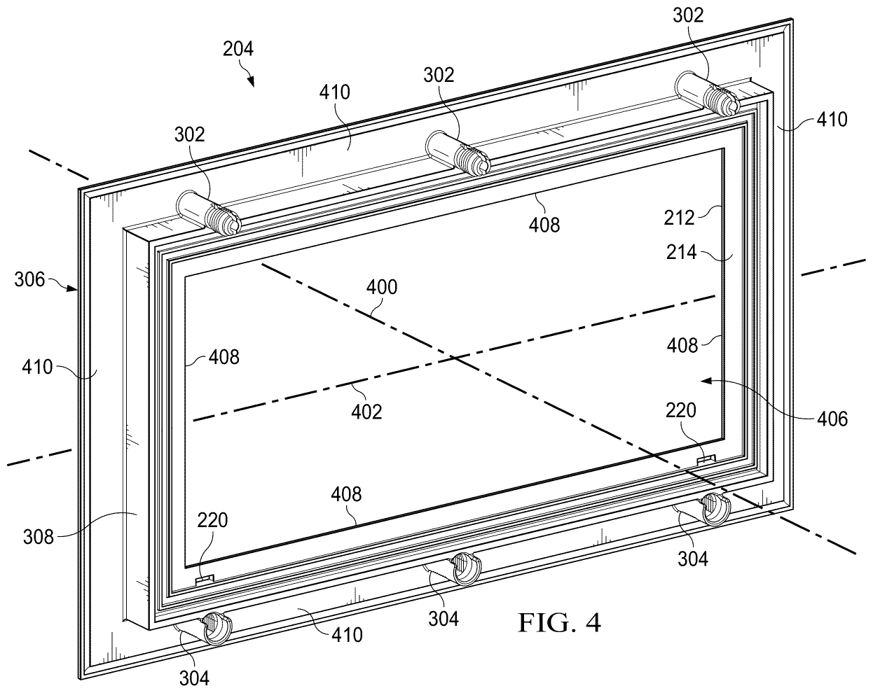

FIG. 4 shows an example frame member 204, separate from the window 106 and the movable barrier 100. As shown, the prong connectors 302 and the receptacle connectors 304 may extend inwardly from the frame member 204 towards the window 106. In the example shown, the connectors 302, 304 extend inwardly from the base portion 306. The connectors 302, 304 are positioned radially outward with respect to the insert portion 308. In some examples, the connectors 302, 304 can be positioned radially inward with respect to the insert portion 308. In yet other examples, the connectors 302, 304 may extend from the insert portion 308 itself. The connectors 302, 304 may be a polymer (e.g., plastic) or a metal, among other materials.

Although the illustrations herein show the frame member 204 having the connectors 302, 304 on the vertically above and vertically below the insert portion 308, the connectors 302, 304 can be positioned on any side or on any part of the frame member 204. In some examples, the connectors 302, 304 are positioned laterally outwardly from the insert portion 308 (e.g., to the left and right sides of the insert portion 308).

One advantage of this disclosure is reducing components, material costs, and assembly time. Various frame members 204 are contemplated to achieve such a result. In some examples, the connectors 302, 304 may be integrated with the frame member 204. This reduces the number of components required for manufacturing, shipping, and assembling. Furthermore, the frame members 204 can connect without the use of a separable fastener. When the connectors 302, 304 are integrated with the frame member 204, the frame member 204 may be formed as one piece. In other examples, the connectors 302, 304 are connected to the frame member 204 after manufacturing the frame member 204.

In FIG. 4, the prong connectors 302 are positioned vertically above the insert portion 308 and the receptacle connectors 304 are positioned vertically below the insert portion 308. An identical or substantially similar frame member 204 to the one shown in FIG. 4 can be used on an opposing side of the movable barrier. By rotating the frame member 204 180 degrees about an axis 400 and rotating the frame member 204 180 degrees about an axis 402, a frame member suitable for use on an opposing side of the movable barrier 100 is obtained. In this way, only one frame member 204 need be manufactured. That is, the frame member 204 on the left side of FIG. 3 may be identical or substantially similar to the frame member 204 on the right side of FIG. 3. The frame members 204 can connect to each other. Another way to explain this advantage is that the frame members 204 may be ambidextrous and will function the same on either the interior side 210 or the exterior side 208 of the movable barrier 100.

Although it may be advantageous to configure the frame member 204 such that the frame member 204 is ambidextrous, there may be other reasons to use two frame members 204 which are different from one another and that are not symmetrical or otherwise ambidextrous. For example, the exterior frame member 204A may have only prong connectors 302 while the interior frame member 204B only has receptacle connectors 304, or vice versa.

Furthermore, although FIG. 4 shows only prong connectors 302 positioned towards the top of the frame member 204 and only receptacle connectors 304 positioned towards the bottom of the frame member, any combination of connectors 302, 304 is possible. For example, the frame member 204 may be manufactured such that there is at least one prong connector 302 and at least one receptacle connector 304 on both the top, bottom, or sides of the frame member 204. Any configuration of the prong connectors 302 and the receptacle connectors 304 is contemplated. Further, the frame member 204 may have more or fewer connectors 302, 304 than shown.

The frame member 204 shown in FIG. 4 has a window opening 406 extending through both the outer side 212 and the inner side 214. In some examples, the window opening 406 is defined by inner trim 408 on the frame member 204. The inner trim 408 may be part of or separate from the base portion 306 or the insert portion 308. In some examples, the inner trim 408 may extend radially inward from the insert portion 308. The inner trim 408 may snap onto or be adhered to the frame member 204 after the window 106 is secured. In some examples, the inner trim 408 is only attached to the frame member 204 positioned on the exterior side 208 of the movable barrier 100.

The circumference of the inner trim 408 is smaller than the circumference of the window 106 and covers an outer edge 412 (shown in FIG. 3) of the window 106. The window opening 406 may be any shape to accommodate any shape that the window 106 might be. In this example, the window opening 406 is rectangular to accommodate a rectangular shape of the window 106. In some examples the window opening may be circular or any other shape. In some examples, the shape of the window opening 406 does not correspond to the shape of the window 106. Rather, the window opening 406 may be of a different shape than the window 106 to give the appearance that the window 106 is the shape of the window opening 406. Even when the window 106 is rectangular, the window opening 406 may be ovular or circular, for example, making the window 106 appear from an observers perspective that the window 106 is actually ovular or circular.

In some examples, the frame member 204 has an outer trim 410 which defines the outer shape of the frame member 204. The outer trim 410 may be part of or separate from the base portion 306. The outer trim 410 may extend radially outward from the insert portion 308. In the example shown, the outer trim 410 gives the frame member 204 a rectangular shape and corresponds with the rectangular shape of the rough opening 300. The outer trim 410 may cover the edges of the rough opening 300, providing the windowed structure 201 a clean and defined look. The shape of the outer trim 410 may not correspond to the shape of the rough opening 300. For example, the rough opening 300 may be rectangular and the outer trim 410 may be ovular or circular.

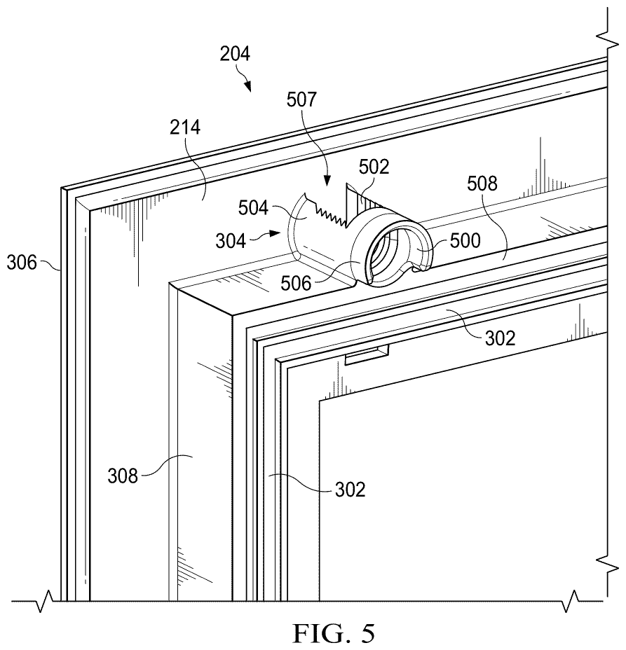

FIG. 5 shows a portion of the frame member 204. The receptacle connector 304 is shown extending from the inner side 214 of the frame member 204 on the base portion 306. In some examples, the receptacle connector 304 includes a socket 500. The socket 500 may be configured to receive the prong connector 302. The socket 500 may be a cavity defined by an inner wall. In some examples, the receptacle connector 304 may have one or a plurality of interference features 502. The interference features 502 may extend along the inner wall of the cavity. The interference features 502 may extend 180 degrees or less about the inner wall of the cavity 500. In some examples, the interference features 502 are ribs 502. The ribs 502 may be a series of protrusions extending radially inwardly within the socket 500. The ribs 502 are shown positioned in a proximal portion 504 of the receptacle connector 304. The ribs 502 may also be positioned in a distal portion 506 as well.

In some examples, as shown in FIG. 5, the proximal portion 504 of the receptacle connector 304 has an opening 507 on one side. The opening 507 may be a side access opening sized to provide access to and is aligned with the interference features 502. The side access opening may have a transverse width sized the same as a transverse width of the cavity 500. The opening 507 may be on a top side or another side of the receptacle connector 304. The opening 507 facilitates the passage of a slide during an injection molding process. The ability to pass the slide in and out of the frame member 204 allows the ribs 502 to be molded as part of the socket 500 of the frame member 204. After the frame member 204 has been molded, the slide is backed away from the frame member 204 through the opening 507 allowing the frame member 204 to be removed from the injection molding apparatus. Without the opening 507, it may be difficult to mold the frame member 204 as one inseparable component having the socket 500 with ribs such as the ribs 502. Forming the frame member 204 as one single component is advantageous as has been described herein to minimize components, decrease assembly time, and simplify the manufacturing and shipping process, among other things. In this way, the disclosure includes this unique and useful method of manufacturing a frame member 204 that can snap together with another frame member 204 and does not require separate components or fasteners. The ribs 502 formed into the frame member 204A during the manufacturing process allow the prong connector 302 having one or more interference features or ribs 602 to snap into the socket 500 having the ribs 502. In this way, at least one of the prong connector 302 and the receptacle connector 304 may be elastically deflectable to allow the one or more interference features 502 to snap fit with the one or more interference features 602 to secure the prong connector 302 with the receptacle connector 304 when in use.

The interference features 502, 602 can be transverse and non-helical interference features. In some examples, the interference features 502, 602 are disposed in a plane perpendicular to an axis of prong connector 302 and the receptacle connector 304 or socket 500.

In other examples, the opening 507 may not be included where the receptacle connector 304 is formed separately from the frame member 204. Further, the opening 507 may have other functions as well, for example, the opening 507 itself may strengthen the connection between the exterior frame member 204A and the interior frame member 204B by allow the prong connector 302 to expand outwards into the opening 507 after being inserted into the socket 500. The opening 507 may serve other purposes as well, for example, it may allow a user to access the prong connector 302 after the prong connector has been inserted into the receptacle connector 304. The opening 507 may enable a user to compress the prong connector 302, allowing retraction of the prong connector 302 from the receptacle connector 304.

In some examples, the circumference of the socket 500 at the distal tip of distal portion 506 is larger (e.g., tapered) than the circumference of the socket 500 at the proximal portion 504 to encourage entry of the prong connector 302 into the socket 500. In some examples, the distal portion 506 of the receptacle connector 304 is not fully enclosed about the circumference. In this way, a portion of the circumference may be open to further accommodate the entry of the prong connector 302 into the receptacle connector 304.

As shown, the receptacle connector 304 may extend inwardly towards the window 106 further than the insert portion 308 extends. In this example, the distal portion 506 of the receptacle connector 304 extends beyond an edge 508 of the insert portion 308. By extending beyond the edge 508, the distal portion 506 can engage the prong connector 302 prior to engagement between the insert portion 308 and the window 106. Engagement of the connectors 302, 304 prior to engagement between the frame member 204 and the window 106 can help to align the opposing frame members on both sides of the window 106. In other examples, the distal portion 506 of the receptacle connector 304 stops short of the edge 508.

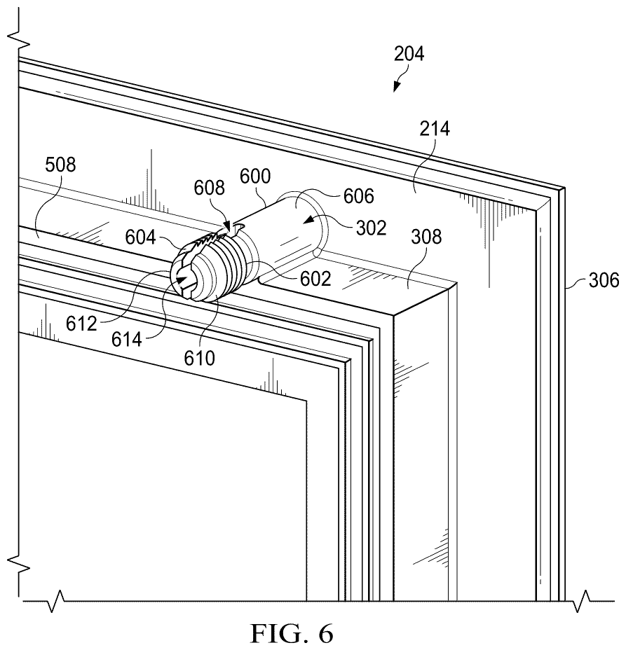

FIG. 6 shows a portion of the frame member 204. The prong connector 302 is shown extending from the inner side 214 of the frame member 204 on the base portion 306. In some examples, the prong connector 302 includes a shaft 600. The shaft 600 may be configured to be inserted into the socket 500 of the receptacle connector 304. In some examples, as discussed above the prong connector 302 may have one or a plurality of interference features 602. The interference features may be ribs 602. The ribs 602 may be a series of protrusions extending radially outward from the shaft 600. The ribs 602 are shown positioned on a distal portion 604 of the prong connector 302. The ribs 602 may also be positioned on a proximal portion 606 as well. In some examples, the circumference of the shaft 600 at a distal tip of the distal portion 604 is smaller (e.g., tapered) than the circumference of the shaft 600 at the proximal portion 606 to encourage entry of the prong connector 302 into the socket 500.

In some examples, the shaft 600 may be interrupted or have a slit 608 extending between the shaft 600. As shown, the slit 608 is extending between the distal portion 604 of the shaft 600 to enable the shaft 600 to flex and bend in a manner that decreases or increases the circumference of the shaft 600. In some examples, the shaft 600 includes a first arm 610 and a second arm 612 that define the slit 608. As the prong connector 302 is inserted into the socket 500 of the receptacle connector 304, the first arm 610 and the second arm 612 are pushed together by the sides of the socket 500. When the first arm 610 and the second arm 612 are pushed together, the overall circumference of the shaft 600 in the portion containing the first and second arms decreases, allowing for simpler insertion throughout the length of the socket 500.

After the shaft 600 has been inserted into the socket 500, the first arm 610 and the second arm 612 can be maintained by the socket 500 in a constant state of compression. The first arm 610 and the second arm 612 can apply opposing outward (radial) forces on the socket 500 as they naturally work to expand and flex back into their original uncompressed state. The deformable semi-compressible structure of the shaft 600 can act like a spring to prevent the prong connector 302 from retracting from the receptacle connector 304. These opposing forces supplied by the shaft 600 and the socket 500 strengthen the connection between frame members 204.

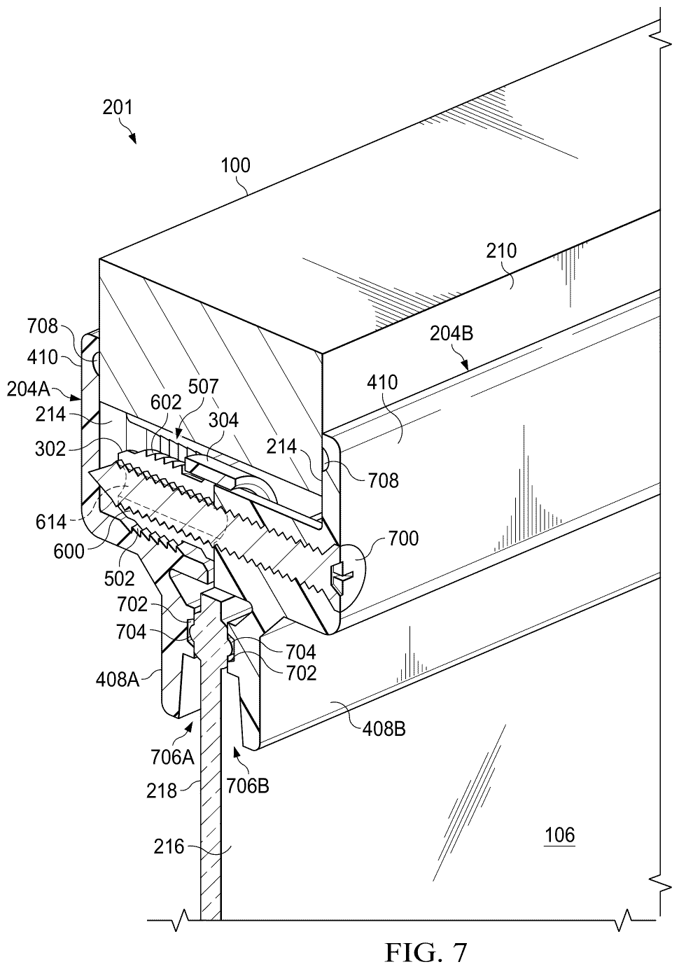

The connection of the frame members 204 can be further strengthened by other aspects of the disclosure. In some examples, the opening 507 in the side of the proximal portion 504 of the socket 500 may accommodate one of the first arm 610 or the second arm 612. One of the arms 610, 612 may expand into the opening 507, further preventing the prong connector 302 from dislodging from the receptacle connector 304. Additionally, in some examples, the ribs 502 and 602 may mesh together to create a one-way connection. Further the prong connector 302 may define a hole 614 extending along the longitudinal axis of the shaft 600. The hole 614 may be configured to receive a fastener 700 extending through the frame member 204. These aspects of the disclosure will be explained more fully below with respect to FIG. 7.

As shown, the prong connector 302 may extend inwardly towards the window 106 further than the insert portion 308 extends. In this example, the distal portion 604 of the prong connector 302 extends beyond the edge 508 of the insert portion 308. By extending beyond the edge 508, the distal portion 604 can engage the receptacle connector 304 prior to engagement between the insert portion 308 and the window 106. Engagement of the connectors 302, 304 prior to engagement of the frame member 204 and the window 106 can help to align the opposing frame members on both sides of the window 106. In other examples, the distal portion 604 of the prong connector 302 stops short of the edge 508.

FIG. 7 shows the prong connector 302 connected to the receptacle connector 304, thereby securing the window 106 between the frame members 204 and in the rough opening 300 of the movable barrier 100. The ribs 502 of the receptacle connector 304 are meshed with the ribs 602 of the prong connector 302. The connection and engagement of the interference features 502 with the interference features 602 increases the strength of the connection between the frame members 204 and the strength with which the window 106 is held between the frame members 204. The ribs 502 and the ribs 602 are configured to allow the shaft 600 to be pushed into the socket 500 and are also configured to prevent the shaft 600 from retracting from the socket 500. Together, the ribs 502, 602 function as a one-way trap. For example, the ribs 502, 602 can be sawtooth teeth with a taper on one side and a flat surface on the other side that allows the shaft or prong 600 to enter the socket 500 but the flat surface may further resist removal of the post or prong 600 from the socket 500. These and the other aspects of the connectors 302, 304 discussed above allow the frame to function without the need for separate components. Separate fasteners are not needed to hold the frame members 204 together because the prong connectors 302 and the receptacle connectors 304 are integrated with the frame member 204. Regardless, the structure of the integrated connectors 302, 304 still allow for the use of additional fasteners such as the fastener 700, to further increase the strength of the connection between the frame members 204.

As shown in FIG. 7, the fastener 700 may extend a) through the outer side 212 of the interior frame member 204B, b) through the hole 614 in the shaft 600, and c) into the inner side 214 of the exterior frame member 204A positioned on the exterior side 208 of the movable barrier 100. The fastener 700 grasps the inner side 214 of the opposing frame member 204 to fasten the two frame members 204 together for added strength. In some examples, the window lite frame assembly 200 is configured such that the one or more fasteners are inserted through the frame member 204 positioned on the interior side 210 of the movable barrier 100. This may be done for aesthetic reasons, to limit the fastener's 700 exposure to elements, and to prevent tampering by outsiders with the window lite frame assembly 200.

The fasteners 700 may be any type of fastener, for example, a screw, a bolt, an anchor, a rivet, a nail, etc. The fastener 700 could also be a plastic or metal post which is adhesively connected to the two frame members 204. In some examples, the hole 614 extending through the shaft 600 also extends through the interior frame member 204B. In some examples however, the hole 614 may not extend through the interior frame member 204B, and rather, the outer side 212 of the interior frame member 204B is marked or indented to indicate where the fastener 700 should be inserted.

The window lite frame assembly 200 does not require the fastener 700 to secure the window 106 to the movable barrier 100. However, the fastener 700 can be added in scenarios that require an especially strong connection between the frame members 204. For examples, some movable barriers 100 operate in areas of extremely high wind. To ensure that the window lite frame assembly 200 can withstand such winds, the fastener 700 may be added. However, the principles described herein (without the fasteners 700) may be suitable for high-wind applications on their own and the fastener 700 may serve as extra support.

FIG. 7 also shows that the frame member 204 may include a groove 702 configured to connect to a tongue or a sealant 704 on the window 106. In some examples, the tongue 704 is part of the window 706. In other examples, the sealant 704 is a bead of sealant applied to the window 706 or during fabrication or during assembly of the window lite frame assembly 200. In yet other examples, the sealant 704 is added in the groove 702 of the frame member 204 before the window 206 is abutted against the frame member 206. As shown, the groove 702 may be positioned on the insert portion 308 of the frame member 204. The tongue or sealant 704 and the groove 702, when abutted against one another, help to stabilize the relationship between the window 106 and the frame members 204. The engagement between the tongue or sealant 704 and the groove 702 increases the clamping force and holding strength that the frame members 204 have on the window 106. Further, the sealant 704 may act to prevent water, air, and debris from flowing through the window lite frame assembly 200. By preventing penetration of all substances, the window lite frame assembly 200 maintains the temperature on the interior side 210 and the exterior side 208 of the movable barrier 100.

In some examples, the sealant 704 may be applied to other portions of the frame member 204, for example, in a groove 708 located in the outer trim 410 of the base portion 106. When added in the groove 708, the sealant 704 prevents water, air, and other debris from traveling between the movable barrier 100 and the frame member 204. The sealant 704 described herein may have adhesive properties. In this way, the sealant 704 may increase the strength of the connection between frame member 204, the window 106, and the movable barrier 100.

FIG. 7 additionally shows that window lite frame assembly 200 may include recesses 706A and 706B. The recesses 706A and 706B are defined by the inner trim 408A and the inner trim 408B, which are offset from the window 206. The recesses 706A and 706B may accommodate various trim inserts (not shown). The trim inserts can be attached to the window lite frame assembly 200 after or before the window 206 is secured. The trim inserts may act as an accessory to the window lite frame assembly 200, depending on the size of the frame members 204 and the desired amount of window exposure. Furthermore, the trim inserts may enhance the aesthetic appeal and finished look of the windowed structure 201.

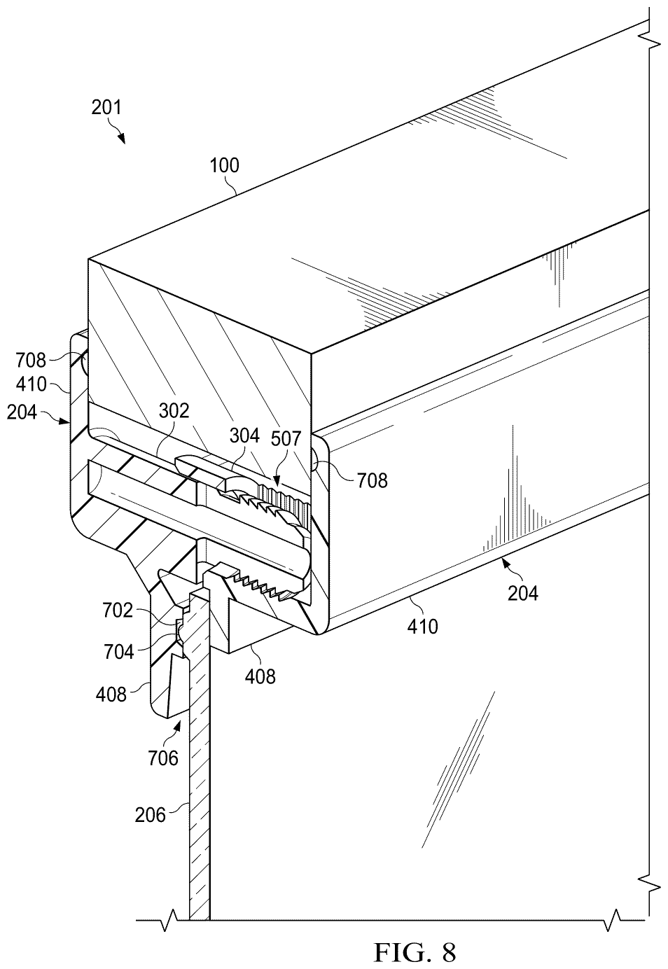

In some examples, as shown in FIG. 8, only one recess 706 is included. For example, the recess 706 may only be present on one side of the window 206 if the trim insert is only desired on one side of the window. This may decrease manufacturing and material costs. In some examples, the trim insert is only used on the side of the window 206 that is exposed to the outside. In other examples, the aesthetic look of the windowed structure 201 is more important on the inside, so the recess 706 is included on the interior side of the windowed structure 201.

In the example of FIG. 8, only one of the frame members 204 has the groove 702 and only one of the sides of the window 106 has the sealant 704. This may be desirable for aesthetic or other reasons. Inner trim 408 of the frame member 204 positioned on the right side of the window 106 does not extend as far downwardly as inner trim 408 of the frame member 204 positioned on the left side of the window 106. The shorter inner trim 408 is shown lying flat against the window 206. In some examples, the sealant and groove connection is only present on the exterior side 208 of the movable barrier 100 because the sealant is only desired on the external side. FIG. 8 also shows the windowed structure 201 without the use of fasteners 700.

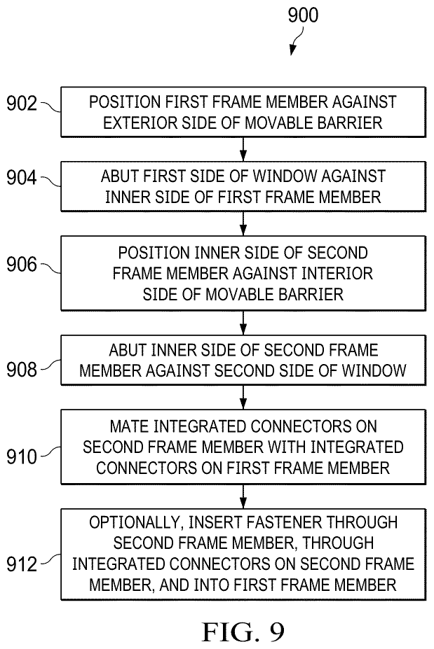

FIG. 9 illustrates an example of a method 900 for securing the window 106 in the movable barrier 100. While FIG. 9 illustrates illustrative operations according to one example, other examples may omit, add to, reorder, and/or modify any of the operations shown in FIG. 9. Any of the operations may be performed manually or automatically.

Operation 902, in some examples, includes positioning the inner side 214 of the exterior frame member 204A against the exterior side 208 of the movable barrier 100. In some examples, the exterior frame member 204A is laid down on a surface and the movable barrier 100 is placed on top of the exterior frame member 204A. In some examples, the sealant 704 may be applied in the groove 708 prior to placement of the movable barrier 100 on top of the exterior frame member 204A. Sometimes, the sealant 704 may be added to the groove 708 during manufacture of the exterior frame member 204A. In yet other examples, the sealant 704 is applied to the exterior frame member 204 such that it fits into the groove 708 once the movable barrier 100 is laid on the exterior frame member 204A. The insert portion 308 may be inserted into the rough opening 300 in the movable barrier 100. The circumference of the insert portion 308 may be smaller than the circumference of the rough opening 300 to allow the insert portion 308 of the exterior frame member 204A to nest within rough opening 300.

Operation 904, in some examples, includes abutting the side 216 of the window 106 against the inner side 214 of the exterior frame member 204A. The window 106 may be inserted through the rough opening 300 and laid on top of the insert portion 308. In some examples, abutting the window 106 against the exterior frame member 204A includes aligning the sealant 704 on the window 106 with the groove 702 in the frame member 204. This stabilizes the and evenly positions the window 106 with respect to the frame member 204. In some examples, where the tongue 704 is sealant, the sealant 704 may be placed in the groove 702 prior to placement of the window 106 on top of the insert portion 308. In other examples, the sealant 704 may be applied to the groove 702 during manufacture of the exterior frame member 204A. In yet other examples, the sealant 704 is applied to the window 106 so that the sealant 704 aligns with the groove 702 when the window 106 is laid on top.

Operation 906, in some examples, includes positioning the inner side 214 of the interior frame member 204B against the interior side 210 of the movable barrier 100. In some examples, the interior frame member 204B is laid on top of the movable barrier 100 which is already resting upon the exterior frame member 204A. In this process, the insert portion 308 of the interior frame member 204B may be inserted through the rough opening 300 in the movable barrier 100. The circumference of the insert portion 308 of the interior frame member 204B may be smaller than the circumference of the rough opening 300 to allow the insert portion 308 of the interior frame member 204B to nest within the rough opening 300. In some examples, the sealant 704 may be applied in the groove 708 prior to placement the interior frame member 204B on top of the movable barrier 100. Sometimes, the sealant 704 may be added to the groove 708 during manufacture of the interior frame member 204B. In yet other examples, the sealant 704 is applied to the exterior frame member 204 such that it fits into the groove 708 once the interior frame member 204B is laid on top of the movable barrier 100.

Operation 908, in some examples, includes abutting the inner side 214 of the interior frame member 204B against the opposing side 218 of the window 106. The insert portion 308 of the interior frame member 204B may be inserted through the rough opening 300 and the insert portion 308 may abut against the window 106. In some examples, abutting the inner side 214 against the window 106 includes aligning the groove 702 of the interior frame member 204B with the tongue 704 on the window 106. In some examples, where the tongue 704 is sealant, the sealant 704 may be placed in the groove 702 prior to placement of the interior frame member 204B on top of the window 706. In other examples, the sealant 704 may be applied to the groove 702 during manufacture of the interior frame member 204B. In yet other examples, the sealant 704 is applied to the window 106 such that it fits into the groove 702 when the insert portion 308 is abutted against the window 106.

Operation 910, in some examples, includes mating the connectors 302, 304 on the interior frame member 204B with the connectors 302, 304 on the exterior frame member 204A. The connectors 302, 304 on the interior frame member 204B and the exterior frame member 204A may be integrated. In this way, the connectors 302, 304 may be inseparable from the frame member 204. By mating the connectors 302, 304 of the interior frame member 204B with connectors of the exterior frame member 204A, the window 106 is secured in the movable barrier 100. In some examples, mating the integrated connectors 302, 304 with the connectors 302, 304 on another frame member 204 includes inserting the shaft 600 of one of the prong connectors 302 into the socket 500 of one of the receptacle connectors 304.

Operation 912, optionally, in some examples, includes inserting the fastener 700 through the interior frame member 204B, through the hole 614 defined by the shaft 600 of one of the connectors 302, and into the exterior frame member 204A. This increases the strength of the connectors between the two frame members 204 and may allow the window lite frame assembly 200 to withstand extreme conditions and heightened external forces and wind loads.

The methods described above can be applied to the movable barrier 100 and the window lite frame assembly 200 as described herein to form the windowed structure 201. If applied, the methods provide advantages including, but not limited to securing a window to a movable barrier using minimal and integrated components, decreasing manufacturing costs of window lite frame assemblies, decreasing the time and complexity of installing a window in a movable barrier, providing an ambidextrous and versatile frame member of a window lite frame assembly.

The example described herein is a window lite frame of a garage door. However, in other embodiments, the window lite frame may be used with any window lite and with any structure, including other doors, walls, vehicles, or other type of window lite applications.

The methods described herein are illustrated as a set of operations or processes. Not all of the illustrated processes may be performed in all examples of the methods. Additionally, one or more processes that are not expressly illustrated or described may be included before, after, in between, or as part of the example processes. In some examples, one or more of the processes may be performed by a controller and/or may be implemented, at least in part, in the form of executable code stored on non-transitory, tangible, computer or machine-readable media that when run by one or more processors may cause the one or more processors to perform one, some, or all of the processes described in relation to the methods herein. Elements illustrated in block diagrams herein may be implemented with hardware, software, firmware, or any combination thereof. One block element being illustrated separate from another block element does not necessarily require that the functions performed by each separate element requires distinct hardware or software but rather they are illustrated separately for the sake of description.

In some instances, well-known methods, procedures, and components have not been described in detail so as not to unnecessarily obscure aspects of the examples. While certain exemplary examples of the present disclosure have been described and shown in the accompanying drawings, it is to be understood that such examples are merely illustrative of and not restrictive on the broad disclosure herein, and that the examples of the present disclosure should not be limited to the specific constructions and arrangements shown and described, since various other modifications may occur to those ordinarily skilled in the art.

What is claimed is:

1. A frame assembly comprising:
a first frame member abuttable against a first side of a window and having first integrated connectors, wherein at least one of the first integrated connectors is a prong connector; and
a second frame member abuttable against an opposing side of the window and having second integrated connectors, wherein at least one of the second integrated connectors is a receptacle connector,
wherein the prong connector is configured to mate with the receptacle connector to secure the window between the first frame member and the second frame member.

2. The frame assembly of claim 1, wherein,
at least one of the first integrated connectors also comprises a receptacle connector, and
at least one of the second integrated connectors also comprises a prong connector.

3. The frame assembly of claim 1, wherein at least one of the first integrated connectors is configured to snap into at least one of the second integrated connectors.

4. The frame assembly of claim 1, wherein the prong connector extends from an inner side of first frame member and the receptacle connector extends from an inner side of the second frame member.

5. The frame assembly of claim 1, wherein the prong connector includes a shaft having first ribs and the receptacle connector includes a socket having second ribs, the first ribs being sized to interfere with the second ribs.

6. The frame assembly of claim 5, wherein inserting the shaft into the socket to secure the window between the first frame member and the second frame member meshes the first and second ribs to prevent the prong connector from retracting from the receptacle connector.

7. The frame assembly of claim 6, wherein inserting the shaft farther into the socket increases a number of first ribs meshed with the second ribs to strengthen a connection between the first frame member and the second frame member.

8. The frame assembly of claim 5, wherein the shaft of the prong connector defines a hole extending along a longitudinal axis of the shaft, the hole configured to receive a fastener extending through the first frame member and into the second frame member, the fastener increasing a strength of a connection between the first frame member and the second frame member.

9. A frame member for securing a window in an opening in a movable barrier, the frame member comprising:
a base portion abuttable against the movable barrier, the base portion being sized larger than an opening in the movable barrier;
an insert portion extending inwardly from the base portion and abuttable against the window, the insert portion being sized to fit within an opening in the movable barrier;
a plurality of integrated connectors extending inwardly from the base portion; and
a window opening defined by the insert portion.

10. The frame member of claim 9, wherein at least one of the plurality of integrated connectors extend inwardly beyond the insert portion.

11. The frame member of claim 9, wherein at least one of the integrated connectors is a prong connector configured to mate with a receptacle connector of a second frame member, the prong connector including a shaft having first ribs.

12. The frame member of claim 9, wherein at least one of the integrated connectors is a receptacle connector configured to mate with a prong connector of a second frame member, the receptacle connector including a socket having second ribs.

13. The frame member of claim 9, wherein the plurality of integrated connectors includes a prong connector configured to mate with a corresponding receptacle connector of a second frame member and includes a receptacle connector configured to mate with a corresponding prong connector of the second frame member.

14. The frame member of claim 9, wherein the insert portion is configured to be inserted into a rough opening in the garage door.

15. The frame member of claim 9, wherein the plurality of integrated connectors are positioned radially outwardly with respect to the insert portion.

16. The frame member of claim 9, wherein the insert portion includes a groove abuttable against a sealant placed on the window.

17. A method of securing a window in a movable barrier, comprising:
positioning an inner side of a first frame member having first integrated connectors against an exterior side of the movable barrier;
abutting a side of a window against the inner side of the first frame member;
positioning an inner side of a second frame member having second integrated connectors against an interior side of the movable barrier;
abutting the inner side of the second frame member against an opposing side of the window; and
mating the second integrated connectors with the first integrated connectors to secure the window in the movable barrier between the first frame member and the second frame member.

18. The method of claim 17, wherein mating the second integrated connectors with the first integrated connectors includes inserting a shaft of one of the second integrated connectors into a socket of one of the first integrated connectors.

19. The method of claim 18, further comprising inserting a fastener through the second frame member, through a hole defined by the shaft of one of the second integrated connectors, and into the first frame member.

20. The method of claim 17, wherein mating the second integrated connectors with the first integrated connectors includes snapping the first and second integrated connectors together.

21. A snap fit connector comprising:
a prong having a perimeter with at least one first interference feature extending about the perimeter; and
a receptacle having a cavity defined by an inner wall, the inner wall having a second interference feature extending along the inner wall, the receptacle having an open end configured to receive the prong and having a side access opening sized to provide access to and aligned with the second interference feature,
at least one of the prong and the receptacle being elastically deflectable in manner allowing the first interference feature to snap fit with the second interference feature to secure the post in the socket when in use.

22. The snap fit connector of claim 21, wherein at least one of the of first and the second interference features is a rib configured to engage with the other of the first and the second interference feature.

23. The snap fit connector of claim 21, wherein the second interference feature extends 180 degrees or less about the inner wall of the cavity.

24. The snap fit connector of claim 21, wherein the side access opening has a transverse width sized the same as a transverse width of the cavity.
